(19) United States
(12) Patent Application Publication
(10) Pub. No.: US 2025/0341218 A1
(43) Pub. Date: Nov. 6, 2025

(54) BEARING STRUCTURE AND TURBOCHARGER

(71) Applicant: IHI Corporation, Tokyo (JP)

(72) Inventor: Takahiro TANAKA, Tokyo (JP)

(73) Assignee: IHI Corporation, Tokyo (JP)

(21) Appl. No.: 19/273,280

(22) Filed: Jul. 18, 2025

Related U.S. Application Data
(63) Continuation of application No. PCT/JP2023/040771, filed on Nov. 13, 2023.

(30) Foreign Application Priority Data
Apr. 14, 2023 (JP) 2023-066482

(51) Int. Cl. F04D 29/059; F04D 17/10; F04D 29/06; F16C 19/08

(52) U.S. Cl. CPC F04D 29/059; F04D 17/10; F04D 29/06; F16C 19/08; F16C 2360/24

(57) ABSTRACT

A bearing structure includes: a shaft; a bearing, which includes an inner ring, an outer ring, and rolling elements provided between the inner ring and the outer ring, and axially supports the shaft; a bearing housing that accommodates the bearing; a side wall portion, which is formed in the bearing housing, and is opposed to the rolling elements in an axial direction of the shaft over an entire area in a circumferential direction of the shaft; an annular groove, which is defined between the side wall portion and the bearing, and extends in the circumferential direction; an oil discharge port formed in the bearing housing and a communication passage, which allows the annular groove and the oil discharge port to be in communication with each other, and passes through the bearing housing in a direction intersecting with the axial direction.

### CROSS REFERENCE TO RELATED APPLICATIONS

This application is a continuation application of International Application No. PCT/JP2023/040771, filed on Nov. 13, 2023, which claims priority to Japanese Patent Application No. 2023-066482, filed on Apr. 14, 2023, the entire contents of which are incorporated by reference herein.

### BACKGROUND ART

### Technical Field

The present disclosure relates to a bearing structure and a turbocharger. This application claims the benefit of priority to Japanese Patent Application No. 2023-066482 filed on Apr. 14, 2023, and contents thereof are incorporated herein.

### Related Art

In various devices, a bearing that axially supports a shaft has been used. For example, in Patent Literature 1, there is disclosed a turbocharger including rolling bearings that axially support a shaft.

### CITATION LIST

### Patent Literature

Patent Literature 1: JP 6168739 B2

### SUMMARY

### Technical Problem

Lubricating oil is supplied to a rolling bearing used in a turbocharger or the like. The lubricating oil supplied to the rolling bearing is discharged from the rolling bearing, and is scattered to the periphery thereof. Thus, in order to prevent the lubricating oil from leaking out to components around the rolling bearing, an improvement in oil sealing performance has been desired.

An object of the present disclosure is to provide a bearing structure and a turbocharger that enable an improvement in oil sealing performance.

### Solution to Problem

In order to solve the above-mentioned problem, according to the present disclosure, there is provided a bearing structure including: a shaft; a bearing, which includes an inner ring, an outer ring, and rolling elements provided between the inner ring and the outer ring, and axially supports the shaft; a bearing housing that accommodates the bearing; a side wall portion, which is formed in the bearing housing, and is opposed to the rolling elements in an axial direction of the shaft over an entire area in a circumferential direction of the shaft; an annular groove, which is defined between the side wall portion and the bearing, and extends in the circumferential direction; an oil discharge port formed in the bearing housing; and a communication passage, which allows the annular groove and the oil discharge port to be in communication with each other, and passes through the bearing housing in a direction intersecting with the axial direction.

The bearing structure may further include: a bearing hole formed in the bearing housing; and a fitting member, which is provided integrally with or separately from the outer ring, and has an outer peripheral surface that is allowed to be fitted onto an inner peripheral surface of the bearing hole. The side wall portion may be opposed to an outer peripheral edge of a side surface of the fitting member in the axial direction over the entire area in the circumferential direction.

The annular groove may have an inner diameter corresponding to an inner diameter of the outer ring.

The bearing structure may further include a guide portion, which is provided in the communication passage, and guides lubricating oil discharged through the communication passage, in a direction toward the oil discharge port.

In order to solve the above-mentioned problem, according to the present disclosure, there is provided a turbocharger including the above-mentioned bearing structure.

### Effects

According to the present disclosure, the oil sealing performance can be improved.

### BRIEF DESCRIPTION OF DRAWINGS

FIG. 1 is a schematic sectional view of a turbocharger according to an embodiment of the present disclosure.

FIG. 2 is an extracted view for illustrating a portion indicated by the one-dot chain lines of FIG. 1.

FIG. 3 is a sectional view for illustrating a cross section taken along the line A-A of FIG. 2.

FIG. 4 is a schematic sectional view of a bearing structure according to a modification example.

### DESCRIPTION OF EMBODIMENTS

Now, with reference to the attached drawings, an embodiment of the present disclosure is described. The dimensions, materials, and other specific numerical values represented in the embodiment are merely examples used for facilitating the understanding of the disclosure, and do not limit the present disclosure otherwise particularly noted. Elements having substantially the same functions and configurations herein and in the drawings are denoted by the same reference symbols to omit redundant description thereof. Further, illustration of elements with no direct relationship to the present disclosure is omitted.

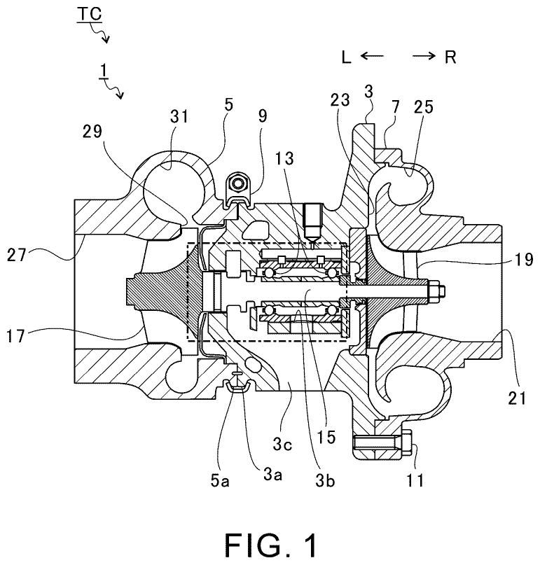

FIG. 1 is a schematic sectional view for illustrating a turbocharger TC. In the following, description is given assuming a direction indicated by the arrow L illustrated in FIG. 1 as a left side of the turbocharger TC. Description is given assuming a direction indicated by the arrow R illustrated in FIG. 1 as a right side of the turbocharger TC. As illustrated in FIG. 1, the turbocharger TC includes a turbocharger main body 1. The turbocharger main body 1 includes a bearing housing 3, a turbine housing 5, and a compressor housing 7. The turbine housing 5 is coupled to a left side of the bearing housing 3 by a fastening mechanism 9. The compressor housing 7 is coupled to a right side of the bearing housing 3 by fastening bolts 11.

A protrusion 3a is formed on an outer peripheral surface of the bearing housing 3. The protrusion 3a is formed on the turbine housing 5 side. The protrusion 3a protrudes in a radial direction of the bearing housing 3. A protrusion 5a is formed on an outer peripheral surface of the turbine housing 5. The protrusion 5a is formed on the bearing housing 3 side. The protrusion 5a protrudes in a radial direction of the turbine housing 5. The bearing housing 3 and the turbine housing 5 are band-fastened by the fastening mechanism 9. The fastening mechanism 9 is, for example, a G coupling. The fastening mechanism 9 clamps the protrusion 3a and the protrusion 5a.

The bearing housing 3 has a bearing hole 3b formed therein. The bearing hole 3b passes through the bearing housing 3 in a right-and-left direction. A pair of bearings 13 are accommodated in the bearing hole 3b. The bearing 13 is a rolling bearing. The bearing 13 axially supports a shaft 15 so as to be rotatable. A turbine impeller 17 is provided at a left end portion of the shaft 15. The turbine impeller 17 is accommodated in the turbine housing 5 so as to be rotatable. A compressor impeller 19 is provided at a right end portion of the shaft 15. The compressor impeller 19 is accommodated in the compressor housing 7 so as to be rotatable. An oil discharge port 3c is formed at the bottom of the bearing housing 3 to discharge lubricating oil scattered from the bearing 13.

An intake port 21 is formed in the compressor housing 7. The intake port 21 is opened on the right side of the turbocharger TC. The intake port 21 is connected to an air cleaner (not shown). A diffuser flow passage 23 is defined by the opposed surfaces of the bearing housing 3 and the compressor housing 7. The diffuser flow passage 23 increases pressure of air. The diffuser flow passage 23 has an annular shape. The diffuser flow passage 23 is in communication with the intake port 21 on a radially inner side through intermediation of the compressor impeller 19.

A compressor scroll flow passage 25 is provided in the compressor housing 7. The compressor scroll flow passage 25 has an annular shape. The compressor scroll flow passage 25 is located, for example, on an outer side with respect to the diffuser flow passage 23 in a radial direction of the shaft 15. The compressor scroll flow passage 25 is in communication with an intake port of an engine (not shown) and the diffuser flow passage 23. When the compressor impeller 19 rotates, the air is sucked from the intake port 21 into the compressor housing 7. The sucked air is pressurized and accelerated in the course of flowing through blades of the compressor impeller 19. The air having been pressurized and accelerated is increased in pressure in the diffuser flow passage 23 and the compressor scroll flow passage 25. The air having been increased in pressure is led to the intake port of the engine.

A discharge port 27 is formed in the turbine housing 5. The discharge port 27 is opened on the left side of the turbocharger TC. The discharge port 27 is connected to an exhaust gas purification device (not shown). A communication passage 29 and a turbine scroll flow passage 31 are formed in the turbine housing 5. The turbine scroll flow passage 31 has an annular shape. The turbine scroll flow passage 31 is located, for example, on an outer side with respect to the communication passage 29 in a radial direction of the turbine impeller 17. The turbine scroll flow passage 31 is in communication with a gas inflow port (not shown). Exhaust gas discharged from an exhaust manifold of the engine (not shown) is led to the gas inflow port. The communication passage 29 allows communication between the turbine scroll flow passage 31 and the discharge port 27 through intermediation of the turbine impeller 17. The exhaust gas having been led from the gas inflow port to the turbine scroll flow passage 31 is led to the discharge port 27 through intermediation of the communication passage 29 and the turbine impeller 17. The exhaust gas led to the discharge port 27 rotates the turbine impeller 17 in the course of flowing.

A rotational force of the turbine impeller 17 is transmitted to the compressor impeller 19 through the shaft 15. When the compressor impeller 19 rotates, the pressure of the air is increased as described above. In such a manner, the air is led to the intake port of the engine.

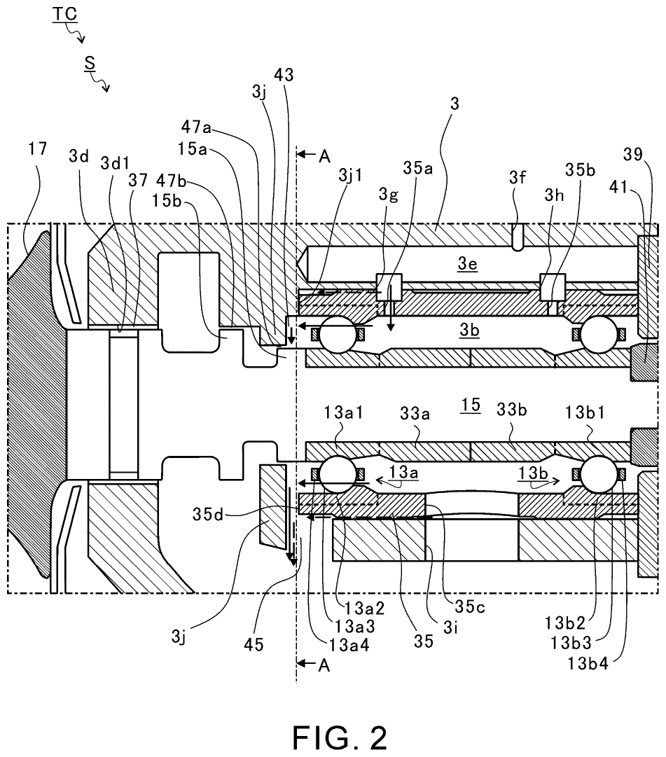

FIG. 2 is an extracted view for illustrating a portion indicated by the one-dot chain lines of FIG. 1. As illustrated in FIG. 2, the bearing housing 3 has a bearing structure S therein. The bearing structure S includes the bearing housing 3, the bearings 13, and the shaft 15. The axial direction, the circumferential direction, and the radial direction of the shaft 15 are hereinafter also referred to simply as “axial direction,” “circumferential direction,” and “radial direction,” respectively.

Two bearings 13, that is, a bearing 13a and a bearing 13b are provided in the bearing hole 3b of the bearing housing 3. The bearing 13a and the bearing 13b are spaced apart from each other in the axial direction. The bearing 13a is placed on the left side of the bearing 13b. The bearing 13a is the bearing 13 on the turbine impeller 17 side. The bearing 13b is the bearing 13 on the compressor impeller 19 side. As described later, lubricating oil is supplied to the bearings 13.

The bearing 13a includes an inner ring 13a1, an outer ring 13a2, rolling elements 13a3, and a cage 13a4. An inner peripheral surface of the inner ring 13a1 is fitted onto an outer peripheral surface of the shaft 15. The inner ring 13a1 rotates integrally with the shaft 15. The outer ring 13a2 is placed coaxially with the inner ring 13a1. The outer ring 13a2 is provided on a radially outer side with respect to the inner ring 13a1. A plurality of rolling elements 13a3 are provided between the inner ring 13a1 and the outer ring 13a2. The cage 13a4 holds the plurality of rolling elements 13a3.

The bearing 13b includes an inner ring 13b1, an outer ring 13b2, rolling elements 13b3, and a cage 13b4. An inner peripheral surface of the inner ring 13b1 is fitted onto the outer peripheral surface of the shaft 15. The inner ring 13b1 rotates integrally with the shaft 15. The outer ring 13b2 is placed coaxially with the inner ring 13b1. The outer ring 13b2 is provided on a radially outer side with respect to the inner ring 13b1. A plurality of rolling elements 13b3 are provided between the inner ring 13b1 and the outer ring 13b2. The cage 13b4 holds the plurality of rolling elements 13b3.

FIG. 2 shows an example of the rolling elements 13a3 and 13b3 each having a spherical shape. However, the rolling elements 13a3 and 13b3 may each have a shape other than the spherical shape, such as a columnar shape and a truncated conical shape.

The inner ring 13a1 is provided integrally with a spacer member 33a. The spacer member 33a has a cylindrical shape. A left end part of the spacer member 33a is connected to a right end part of the inner ring 13a1. The shaft 15 is inserted through the spacer member 33a. The inner ring 13a1 rotates integrally with the spacer member 33a.

The inner ring 13b1 is provided integrally with a spacer member 33b. The spacer member 33b has a cylindrical shape. A right end part of the spacer member 33b is connected to a left end part of the inner ring 13b1. The shaft 15 is inserted through the spacer member 33b. The inner ring 13b1 rotates integrally with the spacer member 33b. A left end part of the spacer member 33b is in abutment against a right end part of the spacer member 33a.

The outer ring 13a2 and the outer ring 13b2 are provided integrally with a fitting member 35. The fitting member 35 has a cylindrical shape. The outer ring 13a2 is connected to a left end part of an inner peripheral portion of the fitting member 35. The outer ring 13b2 is connected to a right end part of the inner peripheral portion of the fitting member 35. An outer peripheral surface of the fitting member 35 is fitted onto an inner peripheral surface of the bearing hole 3b. The outer ring 13a2, the outer ring 13b2, and the fitting member 35 are held so as to be prevented from rotating relative to the inner peripheral surface of the bearing hole 3b.

The bearing housing 3 has a partition wall 3d. The partition wall 3d separates an internal space of the bearing housing 3 and a space in turbine housing 5, in which the turbine impeller 17 is allowed to be accommodated, from each other. A through hole 3d1 is formed in the partition wall 3d. The through hole 3d1 passes through the partition wall 3d in the right-and-left direction. A seal ring 37 is attached to an inner peripheral surface of the through hole 3d1. The left end portion of the shaft 15 is fitted onto an inner peripheral surface of the seal ring 37. The turbine impeller 17 attached to the left end portion of the shaft 15 is placed on the left side of the partition wall 3d.

As described later, lubricating oil is discharged from the bearing 13a to the turbine impeller 17 side. The seal ring 37 prevents the lubricating oil discharged from the bearing 13a from leaking out to the turbine impeller 17. However, it may be difficult to sufficiently prevent leakage of the lubricating oil from the bearing 13a to the turbine impeller 17 only by the seal ring 37. The bearing structure S according to this embodiment has been designed to effectively prevent such leakage of the lubricating oil, as described later.

A branch-origin oil passage 3e is formed in the bearing housing 3. The branch-origin oil passage 3e extends in the axial direction of the shaft 15. The branch-origin oil passage 3e extends substantially in parallel to the bearing hole 3b. The branch-origin oil passage 3e is located vertically above the bearing hole 3b.

The branch-origin oil passage 3e is opened to the right side. A seal plate 39 is attached to the opening of the branch-origin oil passage 3e. The seal plate 39 has a substantially annular shape. The seal plate 39 closes the opening of the branch-origin oil passage 3e. The seal plate 39 has an inner diameter smaller than an inner diameter of the bearing hole 3b. A part of the seal plate 39 on a radially inner side protrudes to a radially inner side of the bearing hole 3b.

A through hole 3f is opened to the branch-origin oil passage 3e. The through hole 3f is formed in the bearing housing 3. The through hole 3f extends from an outside of the bearing housing 3 to the branch-origin oil passage 3e. Oil fed out from an oil pump (not shown) is supplied through the through hole 3f to the branch-origin oil passage 3e.

A through hole 3g and a through hole 3h are formed in the bearing housing 3. Each of the through hole 3g and the through hole 3h passes through the bearing housing 3 from an inner peripheral surface of the branch-origin oil passage 3e to the inner peripheral surface of the bearing hole 3b. Each of the through hole 3g and the through hole 3h allows the branch-origin oil passage 3e and the bearing hole 3b to be in communication with each other. The through hole 3g and the through hole 3h are spaced apart from each other in the axial direction.

A through hole 35a and a through hole 35b are formed in the fitting member 35. Each of the through hole 35a and the through hole 35b passes through the fitting member 35 from the outer peripheral surface of the fitting member 35 to an inner peripheral surface of the fitting member 35. Each of the through hole 35a and the through hole 35b allows the outer peripheral surface of the fitting member 35 and the inner peripheral surface of the fitting member 35 to be in communication with each other. The through hole 35a and the through hole 35b are spaced apart from each other in the axial direction.

The through hole 3g of the bearing housing 3 and the through hole 35a of the fitting member 35 are in communication with each other. Thus, lubricating oil is supplied from the branch-origin oil passage 3e to an inner side of the fitting member 35 through the through hole 3g and the through hole 35a. The through hole 3h of the bearing housing 3 and the through hole 35b of the fitting member 35 are in communication with each other. Thus, lubricating oil is supplied from the branch-origin oil passage 3e to the inner side of the fitting member 35 through the through hole 3h and the through hole 35b.

For example, in FIG. 2, a state in which lubricating oil is supplied from the branch-origin oil passage 3e to the inner side of the fitting member 35 through the through hole 3g and the through hole 35a is indicated by the solid arrows. The lubricating oil supplied to the inner side of the fitting member 35 passes between the inner ring 13a1 and the outer ring 13a2 of the bearing 13a to be discharged to the turbine impeller 17 side. The lubricating oil supplied to the inner side of the fitting member 35 passes between the inner ring 13b1 and the outer ring 13b2 of the bearing 13b to be also discharged to the compressor impeller 19 side.

The lubricating oil supplied from the branch-origin oil passage 3e to the bearing hole 3b is also sent to the outer peripheral surface of the fitting member 35. For example, in FIG. 2, a state in which the lubricating oil is supplied from the branch-origin oil passage 3e to the outer peripheral surface of the fitting member 35 through the through hole 3g is indicated by the dashed arrows. The lubricating oil supplied to the outer peripheral surface of the fitting member 35 is sent leftward along the axial direction to be discharged to the turbine impeller 17 side. The lubricating oil supplied to the outer peripheral surface of the fitting member 35 is sent rightward along the axial direction to be also discharged to the compressor impeller 19 side.

An oil thrower member 41 is provided on a radially inner side with respect to the seal plate 39. The oil thrower member 41 has an annular shape. The oil thrower member 41 is fitted onto the outer peripheral surface of the shaft 15. A left end part of the oil thrower member 41 abuts against a right end part of the inner ring 13b1 of the bearing 13b. The oil thrower member 41 scatters the lubricating oil that has lubricated the bearing 13b on the compressor impeller 19 side, to a radially outer side. As a result, leakage of the lubricating oil from the bearing 13b to the compressor impeller 19 is prevented.

A through hole 35c is formed in a lower part of the fitting member 35. The through hole 35c is located between the bearing 13a and the bearing 13b in the axial direction. The through hole 35c passes through the fitting member 35 from the outer peripheral surface of the fitting member 35 to the inner peripheral surface of the fitting member 35. The through hole 35c allows the outer peripheral surface of the fitting member 35 and the inner peripheral surface of the fitting member 35 to be in communication with each other.

A through hole 3i is formed in the bearing housing 3 at a position facing the through hole 35c of the fitting member 35 in the radial direction. The through hole 3i passes through the bearing housing 3 in the radial direction. The through hole 3i allows the bearing hole 3b and the oil discharge port 3c (see FIG. 1) to be in communication with each other.

The through hole 35c of the fitting member 35 and the through hole 3i of the bearing housing 3 are in communication with each other. Thus, part of the lubricating oil supplied from the branch-origin oil passage 3e to the inner side of the fitting member 35 is discharged downward through the through hole 35c and the through hole 3i. Part of the lubricating oil supplied from the branch-origin oil passage 3e to the outer peripheral surface of the fitting member 35 is discharged downward through the through hole 3i.

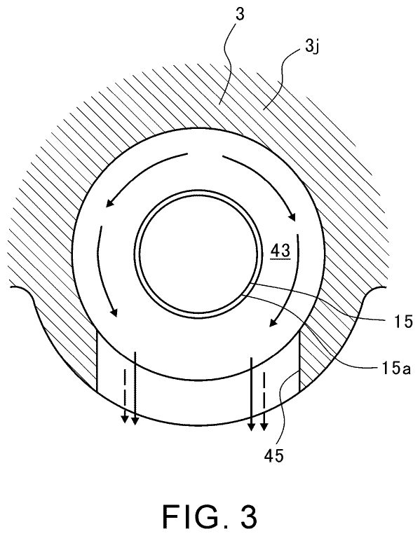

FIG. 3 is a sectional view for illustrating a cross section taken along the line A-A of FIG. 2. As illustrated in FIG. 2 and FIG. 3, a side wall portion 3j is formed in the bearing housing 3. The side wall portion 3j protrudes from the inner peripheral surface of the bearing hole 3b to a radially inner side. The side wall portion 3j is provided on the left side of the bearing 13a on the turbine impeller 17 side. The side wall portion 3j is opposed to a left side surface of the bearing 13a on the turbine impeller 17 side in the axial direction.

The side wall portion 3j has an annular shape. The side wall portion 3j covers the outer peripheral surface of the shaft 15 over an entire periphery in the circumferential direction. An annular groove 43 is defined between the side wall portion 3j and the bearing 13a. The annular groove 43 is a space having a width in the axial direction of the shaft 15 between a right surface of the side wall portion 3j and a left side part of the bearing 13a. The annular groove 43 extends in the circumferential direction. The annular groove 43 is formed coaxially with the shaft 15.

An abutment surface 3j1 is provided at a portion of the right surface of the side wall portion 3j on the radially outer side of the annular groove 43. The abutment surface 3j1 abuts against a left side surface of the outer ring 13a2 of the bearing 13a, and a left side surface 35d of the fitting member 35, in the axial direction. The annular groove 43 is continuous to an inner peripheral edge of the abutment surface 3j1. The annular groove 43 is defined between a portion, except for the abutment surface 3j1, of the right surface of the side wall portion 3j and the left side part of the bearing 13a.

The annular groove 43 has an inner diameter corresponding to an inner diameter of the outer ring 13a2. The inner diameter corresponding to the inner diameter of the outer ring 13a2 may include not only the inner diameter strictly matching the inner diameter of the outer ring 13a2, but also the inner diameter deviating by a value within a predetermined range from the inner diameter of the outer ring 13a2. However, the inner diameter of the annular groove 43 is not always required to correspond to the inner diameter of the outer ring 13a2.

A communication passage 45 is formed in the bearing housing 3. The communication passage 45 is connected to the annular groove 43, and passes through the bearing housing 3 in a direction intersecting with the axial direction of the shaft 15. In the example of FIG. 2 and FIG. 3, the communication passage 45 extends downward from the annular groove 43 to pass through the bearing housing 3 in the radial direction of the shaft 15. However, the extending direction of the communication passage 45 may be inclined with respect to the radial direction when viewed in a direction orthogonal to the axial direction, or may be inclined with respect to a vertical direction when viewed in the axial direction. The communication passage 45 allows the annular groove 43 and the oil discharge port 3c (see FIG. 1) to be in communication with each other.

The side wall portion 3j is opposed to the rolling elements 13a3 in the axial direction of the shaft 15 over an entire area in the circumferential direction of the shaft 15. Accordingly, as shown by the solid arrows in FIG. 2, the lubricating oil having passed between the inner ring 13a1 and the outer ring 13a2 of the bearing 13a on the turbine impeller 17 side to be discharged to the turbine impeller 17 side collides with the side wall portion 3j. Thus, the lubricating oil discharged from the bearing 13a to the turbine impeller 17 side is prevented from leaking out to the turbine impeller 17 side of the side wall portion 3j. Then, after colliding with the side wall portion 3j, the lubricating oil discharged from the bearing 13a to the turbine impeller 17 side passes through the annular groove 43 and the communication passage 45 in the stated order to be discharged downward.

The side wall portion 3j is also opposed to an outer peripheral edge of the side surface 35d of the fitting member 35 in the axial direction of the shaft 15 over the entire area in the circumferential direction of the shaft 15. Accordingly, as indicated by the dashed arrows in FIG. 2, the lubricating oil having passed through the outer peripheral surface of the fitting member 35 to be discharged to the turbine impeller 17 side collides with the side wall portion 3j. Thus, the lubricating oil discharged from the outer peripheral surface of the fitting member 35 to the turbine impeller 17 side is prevented from leaking out to the turbine impeller 17 side of the side wall portion 3j. Then, after colliding with the side wall portion 3j, the lubricating oil discharged from the outer peripheral surface of the fitting member 35 to the turbine impeller 17 side passes through the communication passage 45 to be discharged downward.

A radially expanded portion 15a is formed on the left side of the bearing 13a on the turbine impeller 17 side in the shaft 15. The radially expanded portion 15a has an outer diameter that is expanded with respect to the periphery thereof. A left end part of the inner ring 13a1 of the bearing 13a is in abutment against a right end part of the radially expanded portion 15a. A part of an inner peripheral surface of the side wall portion 3j and a part of an outer peripheral surface of the radially expanded portion 15a are opposed to each other in the radial direction.

A narrowed portion 47a is defined by the side wall portion 3j and the radially expanded portion 15a. The narrowed portion 47a is a portion in which a gap between an inner peripheral surface of the bearing housing 3 and the outer peripheral surface of the shaft 15 is narrowed with respect to the periphery of the portion. With the narrowed portion 47a being defined between the side wall portion 3j and the shaft 15, the lubricating oil discharged from the bearing 13a or the outer peripheral surface of the fitting member 35 to the turbine impeller 17 side is more effectively prevented from leaking out to the turbine impeller 17 side of the side wall portion 3j.

A radially expanded portion 15b that is different from the radially expanded portion 15a is formed on the left side of the radially expanded portion 15a in the shaft 15. The radially expanded portion 15b is a portion of the shaft 15, an outer diameter of which is expanded with respect to the periphery of the portion, similarly to the radially expanded portion 15a. Further, a narrowed portion 47b that is different from the narrowed portion 47a is defined by the inner peripheral surface of the bearing housing 3 and the radially expanded portion 15b. As described above, in the bearing structure S, a plurality of narrowed portions, that is, the narrowed portions 47a and 47b are defined apart from each other in the axial direction of the shaft 15 between the bearing 13a on the turbine impeller 17 side and the seal ring 37. With this configuration, the lubricating oil discharged from the bearing 13a or the outer peripheral surface of the fitting member 35 to the turbine impeller 17 side is still more effectively prevented from leaking out to the turbine impeller 17 side of the side wall portion 3j.

As described above, the bearing structure S according to this embodiment includes: the side wall portion 3j that is opposed to the rolling elements 13a3 in the axial direction of the shaft 15 over the entire area in the circumferential direction of the shaft 15; the annular groove 43 that is defined between the side wall portion 3j and the bearing 13a, and extends in the circumferential direction; and the communication passage 45 that allows the annular groove 43 and the oil discharge port 3c to be in communication with each other, and passes through the bearing housing 3 in the direction intersecting with the axial direction. With this configuration, the lubricating oil having passed between the inner ring 13a1 and the outer ring 13a2 of the bearing 13a to be discharged to the turbine impeller 17 side is caused to collide with the side wall portion 3j to be discharged downward through the annular groove 43 and the communication passage 45, and then can be discharged through the oil discharge port 3c to an outside. Thus, leakage of the lubricating oil to the turbine impeller 17 side can be prevented. As described above, with the bearing structure S according to this embodiment, oil sealing performance can be improved. In addition, the lubricating oil is prevented from stagnating around the bearing 13a. Thus, mechanical loss caused by the stagnation of the lubricating oil is also prevented.

In the example of FIG. 2 and FIG. 3, the side wall portion 3j is provided integrally with the bearing housing 3. However, the side wall portion 3j may be provided separately from the bearing housing 3, and may be attached to the bearing housing 3.

In particular, the side wall portion 3j is opposed to the outer peripheral edge of the side surface 35d of the fitting member 35 in the axial direction of the shaft 15 over the entire area in the circumferential direction of the shaft 15. With this configuration, the lubricating oil having passed through the outer peripheral surface of the fitting member 35 to be discharged to the turbine impeller 17 side is caused to collide with the side wall portion 3j to be discharged downward through the communication passage 45, and then can be discharged through the oil discharge port 3c to the outside. Thus, leakage of the lubricating oil to the turbine impeller 17 side can be more effectively prevented. As a result, oil sealing performance can be more effectively improved.

However, a part of the side wall portion 3j in the circumferential direction of the shaft 15 is not always required to be opposed to the outer peripheral edge of the side surface 35d of the fitting member 35 in the axial direction of the shaft 15.

In the example of FIG. 2 and FIG. 3, the fitting member 35 is provided integrally with the outer ring 13a2. However, the fitting member 35 may be provided separately from the outer ring 13a2. In this case, for example, the fitting member 35 is provided separately also from the outer ring 13b2. Then, an outer peripheral surface of the outer ring 13a2 and an outer peripheral surface of the outer ring 13b2 are fitted onto the inner peripheral surface of the fitting member 35.

In the example of FIG. 2 and FIG. 3, the inner ring 13a1 is provided integrally with the spacer member 33a. However, the inner ring 13a1 may be provided separately from the spacer member 33a. In the example of FIG. 2 and FIG. 3, the inner ring 13b1 is provided integrally with the spacer member 33b. However, the inner ring 13b1 may be provided separately from the spacer member 33b.

In particular, the inner diameter of the annular groove 43 corresponds to the inner diameter of the outer ring 13a2. With this configuration, the lubricating oil having passed between the inner ring 13a1 and the outer ring 13a2 of the bearing 13a to be discharged to the turbine impeller 17 side is prevented from colliding with the abutment surface 3j1. Thus, the lubricating oil discharged from the bearing 13a to the turbine impeller 17 side can be smoothly led to the annular groove 43. Further, as compared to a case in which the inner diameter of the annular groove 43 is larger than the inner diameter of the outer ring 13a2, the abutment surface 3j1 has a larger area. Accordingly, the outer ring 13a2 can be stably positioned by the abutment surface 3j1.

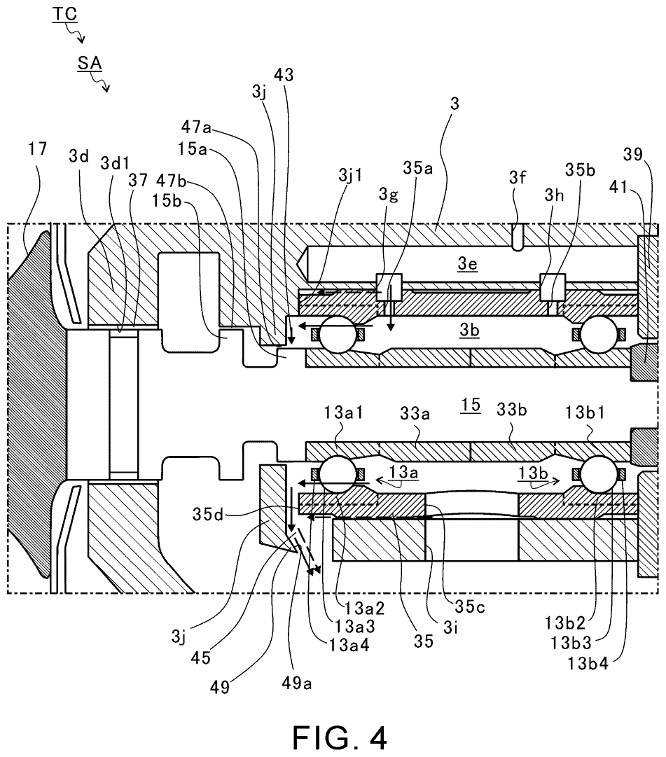

FIG. 4 is a schematic sectional view of a bearing structure SA according to a modification example. The bearing structure SA according to the modification example is different from the above-mentioned bearing structure S according to above-mentioned embodiment in that a guide portion 49 is provided in the communication passage 45.

As illustrated in FIG. 4, the bearing structure SA includes the guide portion 49. The guide portion 49 is provided in the communication passage 45. The guide portion 49 guides the lubricating oil discharged through the communication passage 45, in a direction toward the oil discharge port 3c. In the example of FIG. 4, the guide portion 49 is provided at a portion of side wall portion 3j, which faces the communication passage 45. The guide portion 49 protrudes from a lower end part of the side wall portion 3j in the direction toward the oil discharge port 3c. In the example of FIG. 4, the protruding direction of the guide portion 49 is a lower right direction.

The guide portion 49 has a guide surface 49a that faces the communication passage 45. The guide surface 49a extends in a direction orthogonal to the right-and-left direction and an up-and-down direction, and extends in the lower right direction that is the direction toward the oil discharge port 3c. After colliding with the side wall portion 3j, the lubricating oil discharged from the bearing 13a or the outer peripheral surface of the fitting member 35 to the turbine impeller 17 side is sent to the communication passage 45, and then is guided in the direction toward the oil discharge port 3c by the guide surface 49a of the guide portion 49. With this configuration, the lubricating oil discharged through the communication passage 45 can be scattered toward the oil discharge port 3c. Thus, leakage of the lubricating oil to the turbine impeller 17 side can be more effectively prevented.

An embodiment of the present disclosure has been described above with reference to the attached drawings, but, needless to say, the present disclosure is not limited to the above-mentioned embodiment. It is apparent that those skilled in the art may arrive at various alternations and modifications within the scope of claims, and those examples are construed as naturally falling within the technical scope of the present disclosure.

For example, in the above-mentioned examples, the side wall portion 3j, the annular groove 43, and the communication passage 45 are formed for the bearing 13a on the turbine impeller 17 side in the turbocharger TC. However, the side wall portion 3j, the annular groove 43, and the communication passage 45 may be formed for other bearing 13 instead of the bearing 13a in the turbocharger TC. With this configuration, leakage of the lubricating oil to components other than the turbine impeller 17 that are placed around the bearing 13 can be prevented.

For example, in the above-mentioned examples, the bearing structure S or SA is provided to the turbocharger TC. However, the bearing structure S or SA may be applied to devices including rolling bearings, other than the turbocharger TC.

1. A bearing structure, comprising:
a shaft;
a bearing, which includes an inner ring, an outer ring, and rolling elements provided between the inner ring and the outer ring, and axially supports the shaft;
a bearing housing that accommodates the bearing;
a side wall portion, which is formed in the bearing housing, and is opposed to the rolling elements in an axial direction of the shaft over an entire area in a circumferential direction of the shaft;
an annular groove, which is defined between the side wall portion and the bearing, and extends in the circumferential direction;
an oil discharge port formed in the bearing housing; and
a communication passage, which allows the annular groove and the oil discharge port to be in communication with each other, and passes through the bearing housing in a direction intersecting with the axial direction.

2. The bearing structure according to claim 1, further comprising:
a bearing hole formed in the bearing housing; and
a fitting member, which is provided integrally with or separately from the outer ring, and has an outer peripheral surface that is allowed to be fitted onto an inner peripheral surface of the bearing hole,
wherein the side wall portion is opposed to an outer peripheral edge of a side surface of the fitting member in the axial direction over the entire area in the circumferential direction.

3. The bearing structure according to claim 1, wherein the annular groove has an inner diameter corresponding to an inner diameter of the outer ring.

4. The bearing structure according to claim 1, further comprising a guide portion, which is provided in the communication passage, and guides lubricating oil discharged through the communication passage, in a direction toward the oil discharge port.

5. A turbocharger, comprising the bearing structure of claim 1.

6. A turbocharger, comprising the bearing structure of claim 2.

7. A turbocharger, comprising the bearing structure of claim 3.

8. A turbocharger, comprising the bearing structure of claim 4.
